(19) United States
(12) Patent Application Publication
(10) Pub. No.: US 2025/0224030 A1
(43) Pub. Date: Jul. 10, 2025

(54) INTERNALLY LUBRICATED SHIFT FORK

(71) Applicant: Dana Heavy Vehicle Systems Group, LLC, Maumee, OH (US)

(72) Inventor: Shane T. SMITH, Sylvania, OH (US)

(21) Appl. No.: 18/408,089

(22) Filed: Jan. 9, 2024

(51) Int. Cl. F16H 57/04

(52) U.S. Cl. CPC F16H 57/0424; F16H 57/0468

(57) ABSTRACT

A lubrication system for a clutch. Where the system comprises: a pump; one or more conduits connected to the pump; and at least one body coupled to a shift arm for engaging a sleeve, where the at least one body comprises an inlet connected to a conduit from the one or more conduits, at least one outlet, and an internal passage being in fluid communication between the inlet and the at least one outlet, where lubricant passing through the conduit exits at the at least one outlet to lubricate the body and the sleeve.

### TECHNICAL FIELD

The present description relates to a lubrication distribution system, including a shift fork that is internally lubricated via bodies coupled to the shift fork. The bodies are in surface sharing contact with a sleeve of a clutch and couple the sleeve to the shift fork.

### BACKGROUND AND SUMMARY

Vehicles, such as electrified vehicles, may have a transmission to switch gears of different ratios that produce different output torques and rotational speeds with the same input torque. The transmission may include clutch assemblies that include a clutch, such as a dog clutch or a synchronizer. Each clutch of the transmission may engage or disengage to selectively shift gears or other rotational elements of the transmission, wherein shifting between different gears or other rotational elements may enable different ratios and torque flows through the transmission. The clutch assemblies may be actuated to selectively couple complementary gears via at least an actuator and a shifting rod. Each of the clutch assemblies may physically couple to a shift fork. The shift fork may shiftingly couple a complementary clutch assembly to the shifting rod, such that actuation of the shifting rod may translate the shift fork and components of the clutch assembly in approximately the same direction the shifting rod is actuated. Each of the clutch assemblies may include a sleeve and a hub. Each of the clutch assemblies may physically couple to a complementary shift fork via a plurality of pads. The pads are structures or bodies, such as shift fork and shift sleeve pads, that may physically couple to the shift fork and be in surface sharing contact with features of a sleeve of a clutch assembly. The pads may additionally or alternatively be lubricant pads, and may be referred to as such. When using oil as lubricant, the pads may be oil pads.

An electrified vehicle may transfer rotational energy to a transmission via torque at higher rotational speeds than an internal combustion engine (ICE). At higher speeds and/or the use of a larger sleeve of a clutch for high torques, the surface speed of a sleeve relative to the shift fork may be increased during selectively coupling of rotational elements via a clutch that includes the sleeve. The increased relative rotational speeds of the sleeve may generate increased friction and thermal energy between the bodies and the areas of contact with the sleeve. As a clutch actuates and selectively couples a complementary gear, friction and heat may build up at the pads and a groove or another feature of the sleeve complementary to the bodies. The increased friction and heat, may result in acute or chronic degradation to the bodies, sleeve, or other components of the clutch assembly and shift fork. To decrease the force and heat from resistive forces such as friction, the sleeve and pads may be lubricated. Lubrication may be increased and directed to the area of contact between the bodies and sleeves via applying an increased quantity of lubricant. For one example, splash lubrication may be used to lubricate the sleeve and pads, such as via splashing lubricant from a complementary gear to the clutch assembly. However, at high rotational speeds, the rotation of the sleeve may fling or splash lubricant from sliding sleeve before coating and lubricating the pads. For another example, a sprayer may be used to apply lubricant via targeted spraying to the each of the bodies. However, the use of a sprayer increases the complexity of the system, where each pad may need a sprayer to apply fluid. Likewise, transmission or the areas directly about each of the pads may not have the packing space for housing or positioning the sprayers. Sprayers may also increase the difficulty of removing and disassembling components of the clutch assembly lubricated via the sprayers, as the sprayers may have to be removed or disassembled.

The inventors herein have recognized these and other issues with such systems and have come up with a way to at least partially solve them. As developed in one example, is a lubrication system for a clutch. Where the system comprises: a pump; one or more conduits connected to the pump; and at least one body coupled to a shift arm for engaging a sleeve, where the at least one body comprises an inlet connected to a conduit from the one or more conduits, at least one outlet, and an internal passage being in fluid communication between the inlet and the at least one outlet, where lubricant passing through the at least one body exits at the at least one outlet to lubricate the body and the sleeve.

Lubricant, such as oil, may be up-taken and pressurized by the pump. The pump may send the liquid into a one or a plurality of conduits, such as tubes. Each of the conduits may be in fluid communication and fluidly couple to a complementary body or bodies via an inlet. The body or bodies may shift fork pad or shift fork pads, respectively. Lubricant from a conduit of the conduits may be passed to the inlet of a shift fork pad of the one or more shift fork pads. Lubricant may enter at least a passage of the shift fork pad via the inlet, where the inlet may fluidly couple to at least an oil outlet via the passage. The passage of the shift fork pad, may be the internal passage. Lubricant from the passage may exit the shift fork pad via the oil outlet. Lubricant may exit the oil outlet to coat and lubricate a surface or plurality of surfaces of the shift fork pad. The surface may be a contact surface that may make surface sharing contact with a groove or another feature of a sleeve the shift fork pad may be fit to. The lubrication of the surface may allow the sleeve to rotated freely of the shift fork pad. Lubrication of the surface may reduce the force of friction while reducing and removing thermal energy generated via friction. There may be a plurality of outlets fluidly coupled to the inlet, such as via the passage or another passage. Each outlet of the outlets may fluidly communicate with a contact surface or a plurality of contact surfaces. Lubricant coating the contact surfaces may be removed by the flow of lubricant from the outlet and sheer from the sleeve. After lubricating and absorbing thermal energy from the shift fork pad and the sleeve, the lubricant may be flung off or dripped from the sleeve.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include the transmission of the present disclosure.

FIG. 2 shows an example schematic of a gear assembly of the transmission which includes clutch assemblies and shift forks of the present disclosure.

FIG. 3A shows a side view of an assembly including a clutch assembly and a shift fork of the present disclosure.

FIG. 3B shows the side view of the assembly including a pump and a plurality of conduits.

FIG. 4A shows a side view of the assembly including the clutch assembly and a shift fork of FIGS. 3A-3B.

FIG. 4B shows a side view of the assembly from a region taken from FIG. 4A.

FIG. 5 shows a side view of a body of the present disclosure.

FIG. 6 shows a sectional view of the body.

FIG. 7 shows a sectional view of the body.

### DETAILED DESCRIPTION

The following description relates to one or more bodies that may couple a shift sleeve of a clutch assembly to a shift arm. The one or more bodies may be a pad or a plurality pads, respectively. The pad or pads may be engagement components via which a shifting arm may shiftingly couple to a sleeve of a clutch assembly. The pad or pads may be referred to herein as a shift pad or a plurality of shift pads. Each of the pads may be fit to a complementary component of the sleeve, such as a groove. Likewise, each of the pads may be fit to a complementary component of the shift arm, such as a mounting component. When fit to the complementary component of the sleeve and the complementary component shifts, a shift pad may shiftingly couple the sleeve to the shift arm. The sleeve may be an engaging sleeve of a clutch, such as a clutch collar or clutch ring. The shifting arm may be a shift fork. The shift pad and/or shift pads may therein be a shift fork pad and/or shift fork pads, respectively. One or more of the shift pads may fluidly couple to a conduit supplied with a lubricant via a pump. There may be a plurality of conduits, with at least one conduit complementary to and fluidly coupled to a shift pad, where each of the conduits may fluidly couple to the pump. Lubricant, such as oil, may be up-taken and pressurized by the pump. The pump may drive lubricant through the conduits. Each of the conduits may be in fluid communication and fluidly couple to a complementary shift fork pad.

The shift arm may be shiftingly coupled to a shifting rod, such that the shift fork may be translated approximately in a direction parallel to the direction the shifting rod is actuated. The shifting rod may be shifted by an actuator. The shift arm may be shiftingly coupled to a shifting rod actuated by the actuator. As the shift arm is actuated, the sleeve may be actuated to slide with the shift fork. When shifted by the actuator in a first direction or a second direction opposite to the first direction, the shifting rod and shift fork may engage or disengage the sleeve from an engagement component physically couple to a rotational element, such as a gear. The rotational element physically coupled to the engagement component may be referred to as a target rotational element, such as a target gear.

If the shift arm is a shift fork, the shift fork may comprise a plurality of arms, such as at least two arms. Each of the bodies may be fastened to an arm of the arms of the shift fork. The sleeve may rotate and spin about a longitudinal axis and a hub. The sleeve may rotate when physically coupled to the shift fork via the one or more bodies. The shift fork may have a fitting or plurality of fittings, where each fitting is complementary to a shift pad. The fittings may be through passages, such as through holes that a portion of the shift pad may extend through. The shift pad may have an appendage, such as a stem, that may be fit to the fittings. The mounting components of the shift fork complementary to each shift pad may be comprise the fittings, where each of the mounting components comprises each of the fittings. Each fitting of the shift fork may be complementary to a conduit of the conduits, such that the conduit may fluidly couple to a shift pad via the fitting.

Each of the shift pads may include a pad section and the appendage section. Each of the shift pads may have an inlet and at least an outlet. The inlet and outlet may be an oil inlet and an oil outlet, respectively, that oil may pass through. The inlet may be contiguous and flush with a first surface of the appendage section. The outlet may be contiguous and flush with a second surface or a plurality of second surface of the pad section. The second surface or second surfaces may be contact surfaces that may make surface sharing contact with a groove or another feature of the sleeve the shift pad may fit to. The inlet and outlet may be fluidly coupled and in fluid communication via at least a passage. Lubricant may enter at least one of the shift pads via the inlet complementary to the at least one shift pad. Lubricant from the passage may exit at least one of the shift pads via the oil outlet to the at least one shift pad. Lubricant may enter each of the shift pads via the inlet. Lubricant from the passage may exit the each of the shift pads via the oil outlet. Lubricant may exit the outlet to coat and lubricate a surface or plurality of surfaces of the shift fork pad. The lubrication of the surfaces, such as contact surfaces, may allow the sleeve to rotate freely of the shift fork pad while reducing the force of friction and thermal energy generated via friction. There may be a plurality of outlets fluidly coupled to the inlet, such as via the passage. Each outlet of the outlets may be flush with, contiguous with, and fluidly coupled to a contact surface or a plurality of contact surfaces. Lubricant coating surfaces of the pad section may be removed by the flow of lubricant from the outlet and sheer from the sleeve. After lubricating and absorbing thermal energy from the shift fork pad and the sleeve, the lubricant may be flung off or dripped from the sleeve.

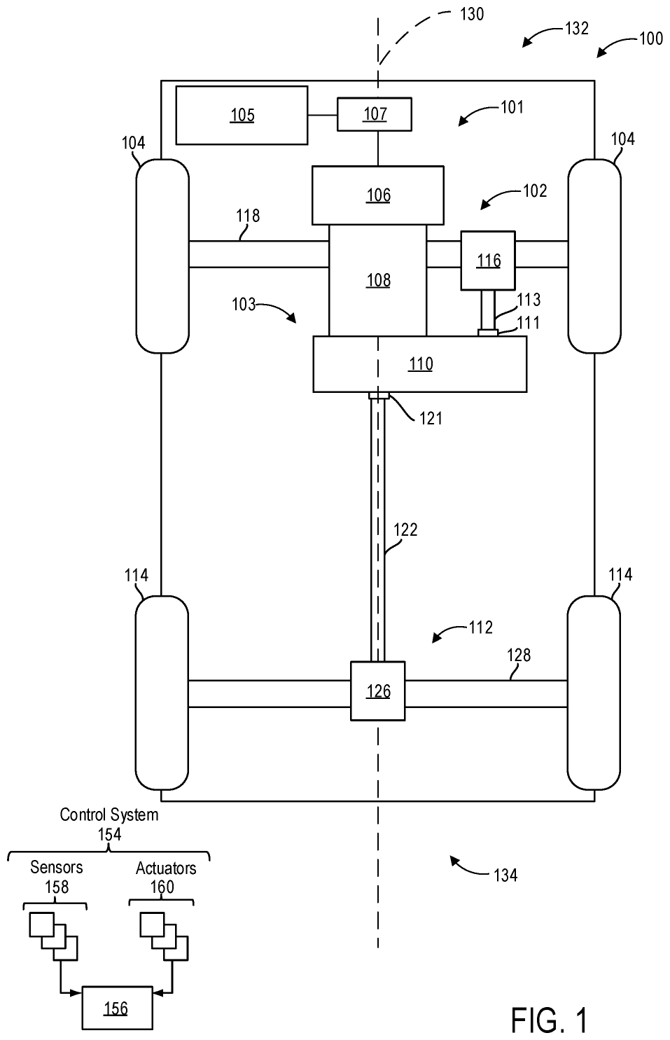

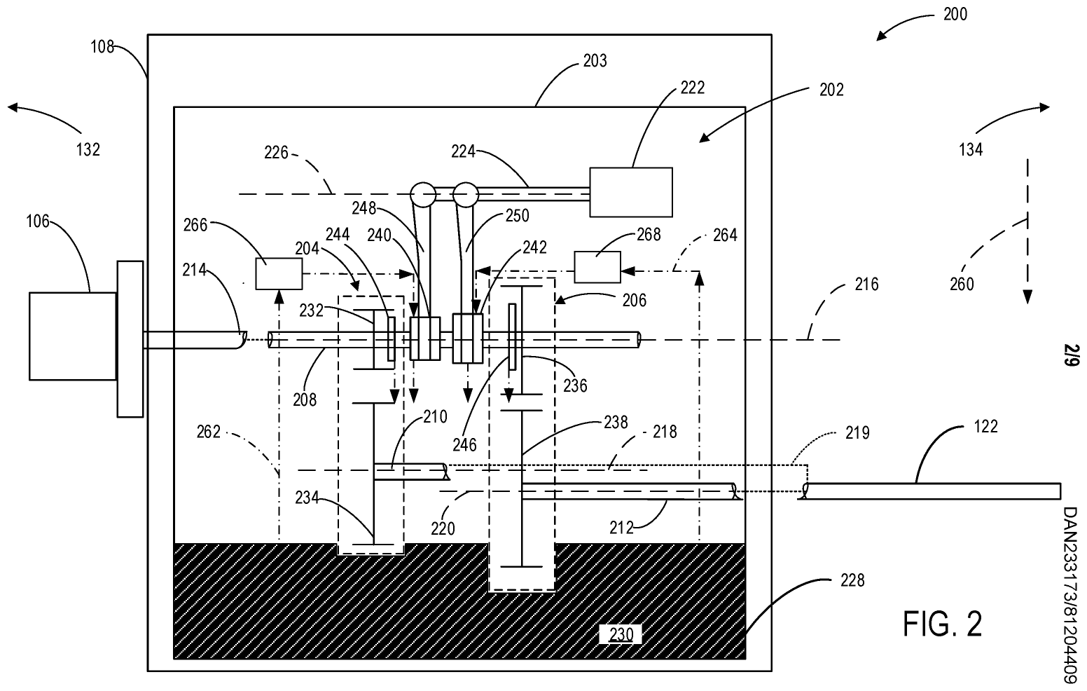

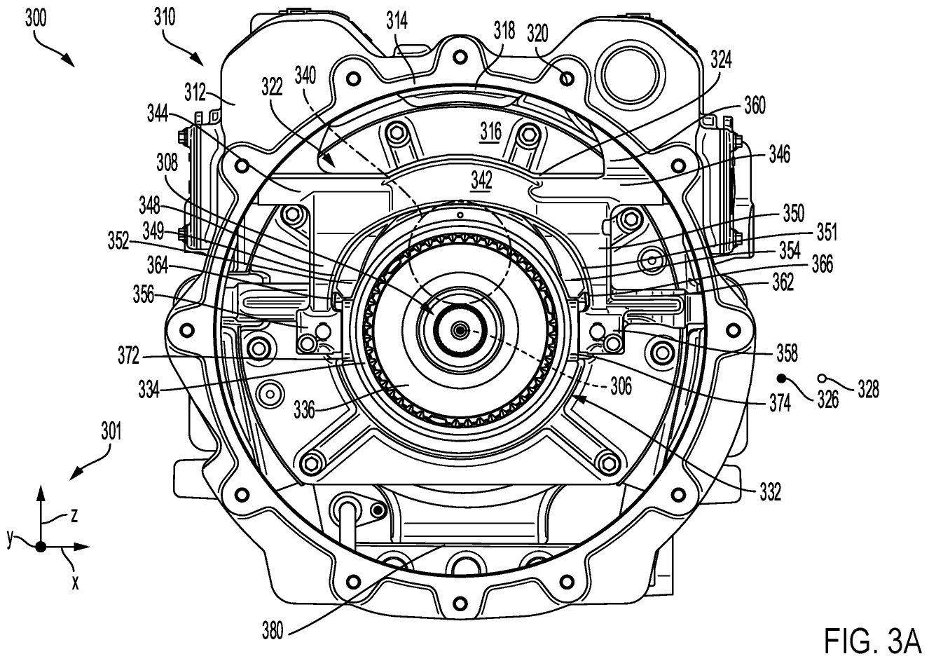

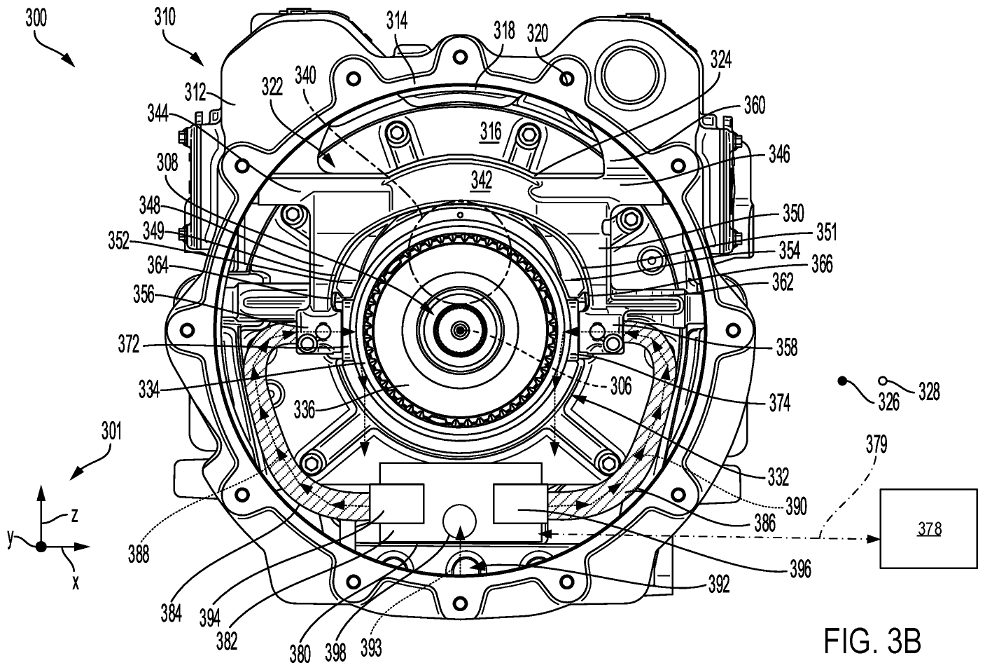

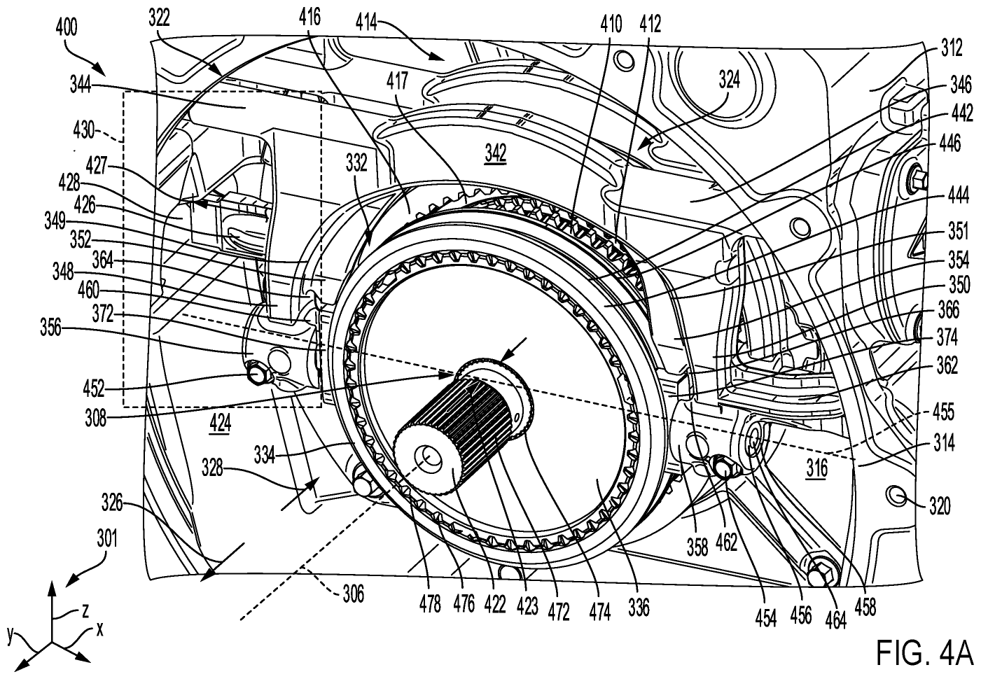

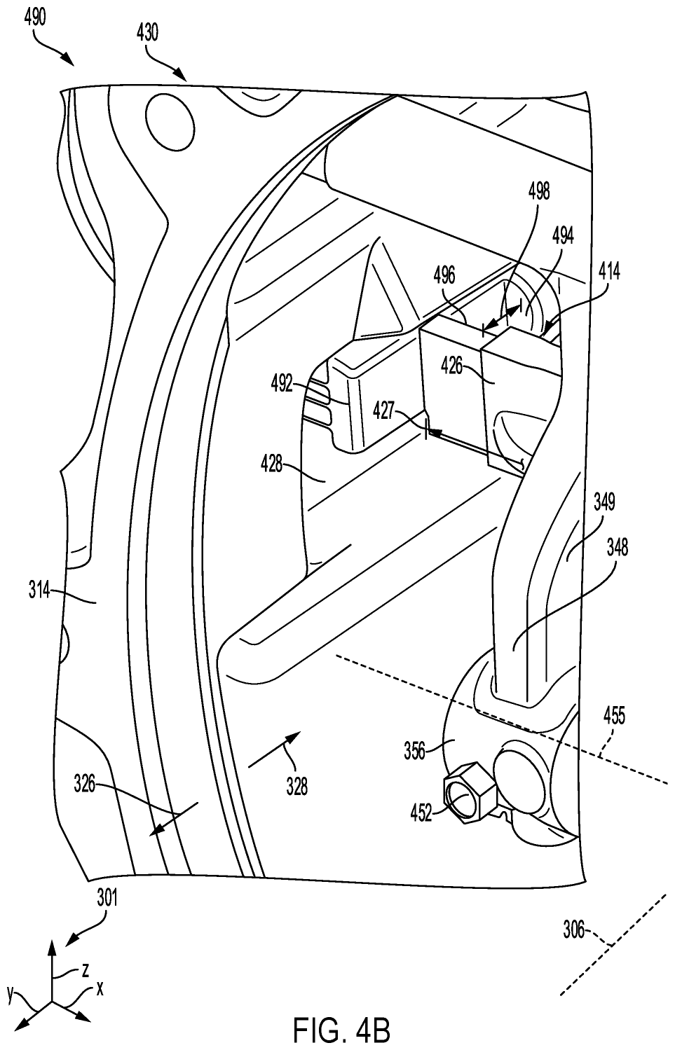

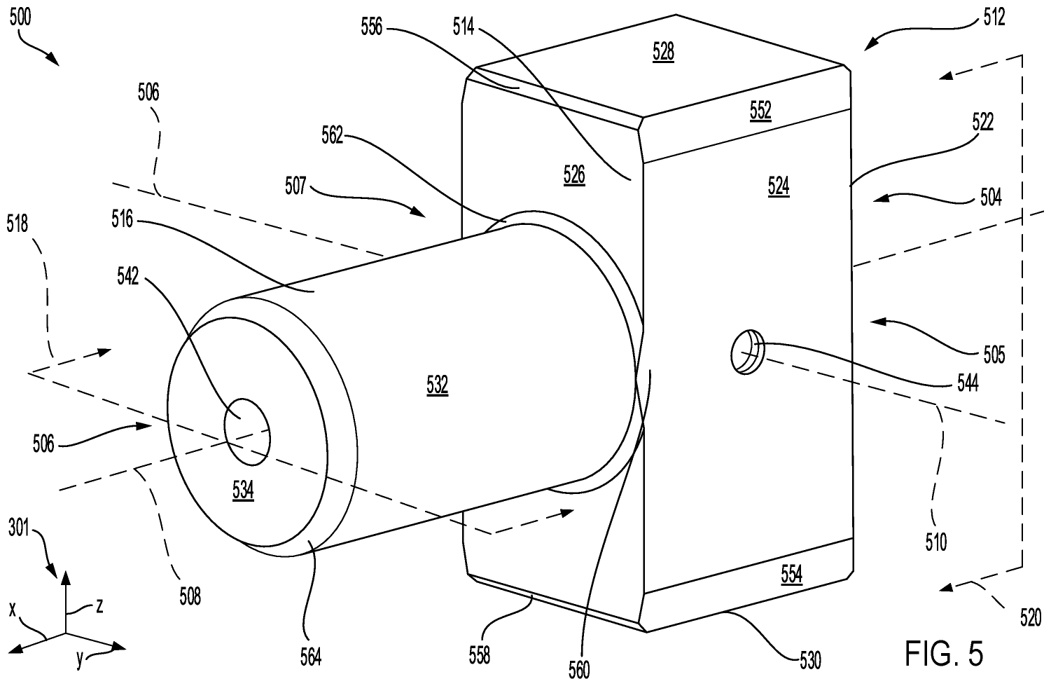

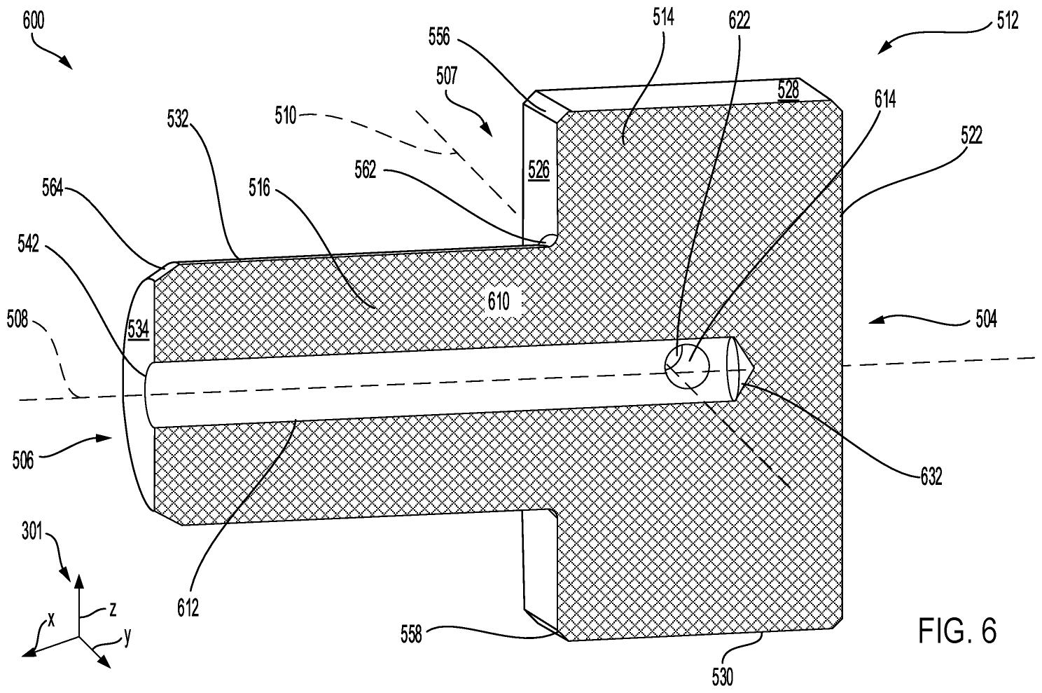

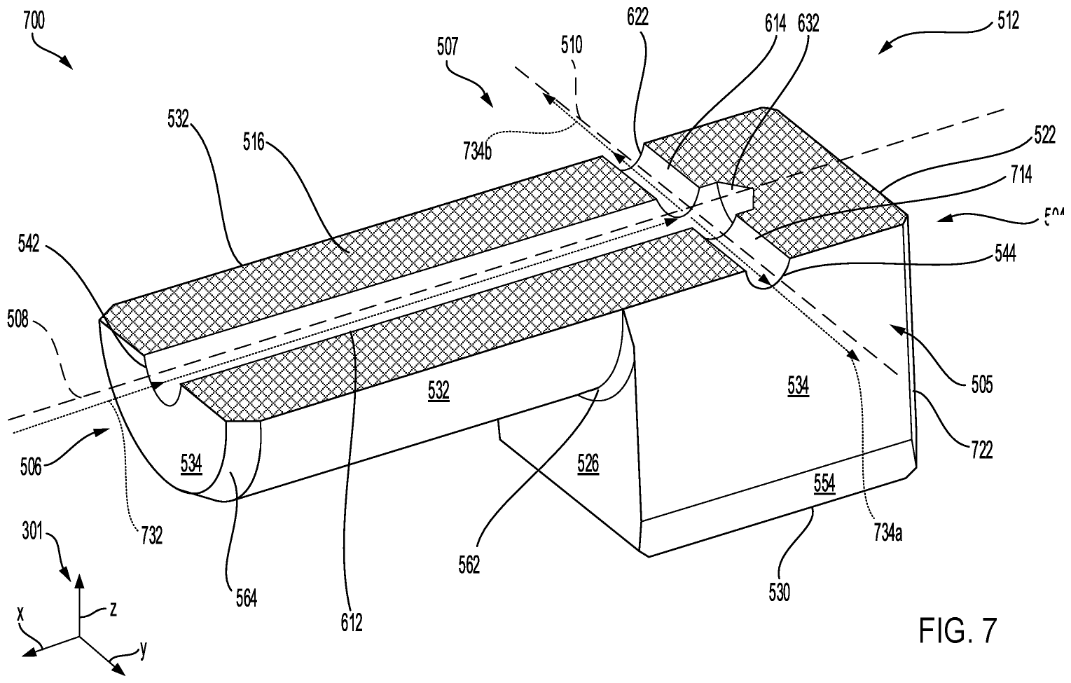

FIG. 1 shows an example schematic of a vehicle which may include the transmission of the present disclosure. The vehicle in FIG. 1 may be an electrified vehicle such as an EV or a hybrid vehicle with multiple sources of torque that may include an electric motor, a hydrogen fuel cell, and/or a non-internal combustion (ICE) engine. FIG. 2 shows an example schematic of a gear assembly of the transmission which includes clutch assemblies and shift forks of the present disclosure. FIG. 3A shows a side view of an assembly including a clutch assembly and a shift fork of the present disclosure. The assembly of FIG. 3A includes a housing about a shifting assembly, wherein the shifting assembly may include clutch assemblies, shift forks, and rotational elements complementary to the clutches, such as shafts and gears. FIG. 3B shows the side view of the assembly of FIG. 3A including a pump and a plurality of conduits. The view of FIGS. 3A-3B is a side view of the assembly showing the clutch assembly and shift fork positioned about a shaft and longitudinal axis that are normal to the first view. FIG. 4A shows a side view of the assembly including the clutch assembly and a shift fork of FIG. 3A. FIG. 4A shows additional features such as inner surfaces, recesses, and holes of the housing and features of the shifting assembly, such as additional sleeves, additional rotational elements, and an additional shift fork. FIG. 4B shows a view of the assembly from a region taken from FIG. 4A. The region of FIG. 4B shows a position sensor that may be used with a target of a shift fork. FIG. 5 shows a side view of body of the present disclosure. FIG. 6. shows a sectional view of the body. FIG. 7 shows a sectional view of the body. The sectional view of the FIG. 6 is taken on a first plane perpendicular to a second plane that the sectional view of FIG. 7 may be taken on. FIGS. 5-7 show the sleeve engagement isolated from other components of the assembly shown in FIGS. 3A-4B.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIGS. 1-2 shows schematics of an example configuration with relative positioning of the various components. FIGS. 3A-7 show example configurations with approximate position. FIGS. 3A-7 are shown approximately to scale; though other relative dimensions may be used. As used herein, the terms “approximately” is construed to mean plus or minus five percent of the range unless otherwise specified.

Further, FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis. Features described as lateral may be approximately parallel with the lateral axis. A vertical axis may be normal to a lateral axis and a longitudinal axis. Features described as vertical may be approximately parallel with a vertical axis.

Turning now to FIG. 1, a vehicle 100 is shown comprising a powertrain 101 and a drivetrain 103. The vehicle 100 may have a front end 132 and a rear end 134, located on opposite sides of vehicle 100. Objects, components, and features of the vehicle 100 referred to as being located near the front may be closest to the front end 132 compared to the rear end 134. Objects, components, and features of the vehicle 100 referred to as being located near the rear may be closest to the rear end 134 compared to the front end 132. The powertrain 101 comprises a prime mover 106 and a transmission 108. The prime mover 106 may be an internal combustion engine (ICE) or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting. Additionally, there may be other movers in the vehicle besides prime mover 106. If the prime mover 106 is an ICE there may be at least a second mover with an input to the transmission 108, wherein the second mover may be an electric machine such as an electric motor. In one example, if there are a single or plurality of second movers in addition to the prime mover 106, the vehicle 100 may be a hybrid vehicle, wherein there are multiple torque inputs to the transmission 108. The vehicle 100 may have a longitudinal axis 130. The powertrain 101 and drivetrain 103 may have a length parallel with the longitudinal axis 130.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be plane, a boat, or other vehicle system that utilizes lubricant. Additionally or alternatively, the vehicle 100 and/or one or more of its components, such as components of the powertrain 101 and/or drivetrain 103, may be used in industrial, locomotive, military, agricultural, and/or aerospace applications. In one example, the vehicle 100 is an all-electric vehicle or a vehicle with all-electric modes of operation, such as a plug-in hybrid vehicle. As such, the prime mover 106 is an electric machine. In one example, the prime mover 106 is an electric motor/generator.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a rear-wheel drive or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing. The first driveshaft 113 and second driveshaft 122 may be positioned to extend in parallel with the longitudinal axis 130. For an example of a configuration of vehicle 100, the second driveshaft 122 may be centered about the longitudinal axis 130.

The first differential 116 may supply a FWD in some capacity to vehicle 100, as part of rotary power transferred via the first driveshaft 113. Likewise, the second differential 126 may supply a RWD to vehicle 100, as part of the rotary power transferred via the second driveshaft 122. The first differential 116 and the second differential 126 may supply a FWD and RWD, respectively, as part of an AWD mode for vehicle 100.

Adjustment of the drivetrain 103 between the various modes as well as control of operations within each mode may be executed based on a vehicle control system 154, including a controller 156. Controller 156 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 156 may be a powertrain control module (PCM).

Controller 156 may receive various signals from sensors 158 coupled to various regions of vehicle 100. For example, the sensors 158 may include sensors at the prime mover 106 or another mover to measure mover speed and mover temperature, a pedal position sensor to detect a depression of an operator-actuated pedal, such as an accelerator pedal or a brake pedal, speed sensors at the first and second set of wheels 104, 114, etc. Vehicle acceleration is directly proportional to accelerator pedal position, for example, degree of depression. Upon receiving the signals from the various sensors 158 of FIG. 1, controller 156 processes the received signals, and employs various actuators 160 of vehicle 100 to adjust drivetrain operations based on the received signals and instructions stored on the memory of controller 156. For example, controller 156 may receive an indication of depression of the brake pedal, signaling a desire for decreased vehicle speed. In response, the controller 156 may command operations, such as shifting gear modes of the transmission 108. Alternatively, the gear modes of the transmission 108 may be shifted manually, such as if the transmission 108 is a manual transmission.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

In some embodiments, additionally or alternatively, the transmission 108 may be a first transmission, further comprising a second transmission arranged on the second set of axle shafts 128. Herein, the transmission 108 may be interchangeably referred to as a gearbox.

Turning to FIG. 2, a schematic 200 of the transmission 108 illustrated with reference to FIG. 1 is shown. The transmission 108 includes a volume that may be referred to as a gear enclosure 203. In an example of a configuration, the gear enclosure 203 may house a gear assembly 202. The gear enclosure 203 may house or house portions of a plurality of shafts that support rotational elements of the gear assembly 202. The transmission 108 may be a gearbox, such as a multi-stage reduction gearbox, where the gear assembly 202 acts as a system of a plurality of reduction sets. The gear assembly 202 may be formed of at least two reduction sets that may reduce the rotational speed (e.g., rotation per minute (RPM)) and increase the torque. The reduction sets may be referred to herein as stages. The stages may be gearsets. There may be a first stage 204 and second stage 206. The first stage 204 and second stage 206 may include gears, such as fixed gears.

As an example, the enclosure 203 of the transmission 108 may contain a first shaft 208, a second shaft 210, and a third shaft 212. The first stage 204 may be supported by the first shaft 208 and the second shaft 210. The second stage 206 may be supported by the first shaft 208 and the third shaft 212. The first shaft 208 may be an input to the first stage 204 and second stage 206. The second shaft 210 may act as an output for the first stage 204. The third shaft 212 may act as an output for the second stage 206. The first stage 204 may drivingly couple to the first shaft 208 to the second shaft 210. The second stage 206 may drivingly couple the first shaft 208 to the third shaft 212. The first shaft 208 may be centered on a first axis 216. The second shaft 210 may be centered on a second axis 218. The third shaft 212 may be centered on a third axis 220. The first axis 216, second axis 218, and third axis 220 may be parallel with one another. The first stage 204 may traverse the first axis 216 to the second axis 218. The second stage 206 may traverse the first axis 216 to the third axis 220. The first shaft 208 may drivingly couple a first input shaft to gear assembly 202. For the example shown in schematic 200, the first input shaft may be an output shaft 214 of the prime mover 106. The output shaft 214 may be referred to herein as the prime mover output shaft 214. For this example, the prime mover 106 may be a first electric machine, such as a first electric motor. Shafts and other components that may be drivingly coupled but not directly contacting may be represented by dotted lines 219.

However, other configurations of the gearbox are possible. For example, the first input shaft may be a shaft drivingly coupled to output shaft 214 or the output of another reduction set. Additionally, for other configurations, there may be only a single shaft, such as second shaft 210, that may be selectively and drivingly coupled to the first shaft 208 via reduction ratios. For example, the first stage 204 and second stage 206 may selectively and drivingly couple the first shaft 208 to the second shaft 210.

The second shaft 210 and third shaft 212 may be drivingly coupled to a first output shaft. For the example shown in schematic 200, the first output shaft may be a drive shaft, such as the second driveshaft 122. However, other configurations of the gear assembly 202 and enclosure 203 are possible. For example, the first output shaft may be a shaft drivingly coupled to a drive shaft, such as the second driveshaft 122, or to another reduction set. Additionally, for other examples, the second shaft 210 and/or third shaft 212 may be drivingly coupled to separate outputs shafts. For example, the second shaft 210 may be drivingly coupled a first output shaft, such as the first driveshaft 113 of FIG. 1. For this example, the third shaft 212 may be drivingly coupled to a second output shaft, such as the second driveshaft 122. Additionally, for other examples, the second shaft 210 and/or third shaft 212 may be output shafts.

An actuator 222 may be used to selectively and drivingly couple the first stage 204 or second stage 206 to the first shaft 208. The actuator 222 may be drivingly coupled to a shifting rod 224. The actuator 222 may be mounted to the transmission 108 or a component of the transmission 108, such as the walls and surfaces of the enclosure 203. For one example, the actuator may be mounted via fastening by a plurality of fasteners, such as screws. For another example, the actuator may be fit to a recess or void of surfaces and material of the transmission 108. The actuator 222 may be one of the actuators 160 of FIG. 1.

The actuator 222 may translate the shifting rod 224 along a fourth axis 226. When translated in a first direction, such as toward the front end 132, the shifting rod 224 may drivingly couple the first stage 204 to the first shaft 208. When translated in a second direction, such as toward the rear end 134, the shifting rod 224 may drivingly couple the second stage 206 to the first shaft 208. The shifting rod 224 may be guided by the housing of the transmission 108 and/or enclosure 203. For an example, the actuator 222 may be a shift lever.

The enclosure 203 may include a sump 228 where work fluid 230 may rest. The work fluid 230 may be a lubricant, such as oil. The sump 228 may be located below the gear assembly 202, such that work fluid 230 may be returned to the sump 228 via the force of gravity 260. After lubricating the gears of the first stage 204 and second stage 206, work fluid 230 may be returned to the sump 228 via splashing and dripping.

The first stage 204 and second stage 206 may include a plurality of gears. Both the first stage 204 and second stage 206 may each include at least two gears. For an example, the first stage 204 may include a first gear 232 and a second gear 234. For this example, the second stage 206 may include a third gear 236 and a fourth gear 238.

There may be a plurality of arms and engagements via which the shifting rod 224 and actuator 222 may drivingly couple reduction sets. There may be at least one arm and two engagements drivingly coupled to the shifting rod 224 to select reduction sets. The number of arms and engagements drivingly coupled to the shifting rod 224 may be dependent on the number of sets to engage. The first stage 204 may drivingly couple to the first shaft 208 via a first engagement 240 and first coupling 244. Likewise, the second stage 206 may drivingly couple to the first shaft 208 via a second engagement 242 and second coupling 246. The first engagement 240 and second engagement 242 may drivingly couple to the shifting rod 224 via a first arm 248 and second arm 250, respectively.

The first coupling 244 and second coupling 246 may be drivingly coupled to the first gear 232 and second gear 234, respectively. The first engagement 240 and first coupling 244 may form a clutch, such as a synchronizer clutch or a dog clutch. The second engagement 242 and second coupling 246 may form a clutch. The first engagement 240 and second engagement 242 may each be synchronizers.

Schematic 200 shows a first path 262 that the work fluid 230 may take from the sump 228. The flow of work fluid 230 on the first path 262 may be driven from suction of a first pump 266. Likewise, schematic 200 shows a second path 264 the work fluid 230 may take from the sump 228. The flow of work fluid 230 on the second path 264 may be driven from suction of a second pump 268.

The first path 262 may begin at the sump 228. Work fluid 230 may be drawn to the first pump 266. The first pump 266 may increase the pressure of and direct the work fluid 230 to the first arm 248. Work fluid 230 may enter and be distributed through the first arm 248 and the first engagement 240 via a plurality of fluid passages. The work fluid 230 may coat and lubricate the components of the first engagement 240. The work fluid 230 may coat and lubricate the first coupling 244, such as when the first coupling 244 is engaged with the first engagement 240. The work fluid 230 may drip from the first engagement 240 and the first coupling 244 back to the sump 228.

The second path 264 may begin at the sump 228. Work fluid 230 may be drawn to the second pump 268. The second pump 268 may increase the pressure and direct the work fluid 230 to the second arm 250. Work fluid 230 may enter and be distributed through the second arm 250 and the second engagement 242 via a plurality of fluid passages. The work fluid 230 may coat and lubricate the components of the second engagement 242. The work fluid 230 may coat and lubricate the second coupling 246, such as when second coupling 246 is engaged with the second engagement 242. The work fluid 230 may drip from the second engagement 242 and the second coupling 246 back to the sump 228.

Schematic 200 shows a single shifting rod, shifting rod 224, that may be shifted by the actuator 222. The shifting rod 224 may physical couple to and actuate the first arm 248 and the second arm 250. However, it is to be appreciated that the schematic 200 is non-limiting and there may be a plurality of shifting rods and actuators. For example, there may be a plurality of shifting rods shifted by actuator 222. For another example, there may be a plurality of shifting rods wherein each shifting rod is shifted by an actuator specifically coupled to each shifting rod. For these examples, each shifting rod may be specific to an arm, such as the first or second arm 248, 250, that may be used to actuate engagements, such as the first or second engagement 240, 242.

A set of reference axes 301 are provided for comparison between views shown in FIG. 3A-7. The reference axes 301 indicate a y-axis, an x-axis, and a z-axis. In one example, the z-axis may be parallel with a direction of gravity, and the x-y plane may be parallel with a horizontal plane that an assembly 310 and a body 512 may rest upon. When referencing direction, positive may refer to in the direction of the arrow of the y-axis, x-axis, and z-axis and negative may refer to in the opposite direction of the arrow of the y-axis, x-axis, and z-axis. A circle may represent an axis of the reference axes 301 that is normal to a view. A filled circle may represent an arrow and axis facing toward, or positive to, a view. An unfilled circle may represent an arrow and an axis facing away, or negative to, a view.

Turning to FIG. 3A, it shows a first view 300 of the assembly 310 positioned about a longitudinal axis 306. The assembly 310 may comprise of a housing 312 and a shifting assembly 322 about a shaft 308. The shaft 308 may be centered about the longitudinal axis 306, such that a centerline of the shaft 308 may be approximately collinear with the longitudinal axis 306. The longitudinal axis 306 may be a central axis and rotational axis for the shaft 308 and rotational elements of the shifting assembly 322. The shaft 308 may support gears and may selectively couple to gears via the shifting assembly 322. The first view 300 may be normal to the longitudinal axis 306 and the y-axis of the reference axes 301. As shown in the first view 300, the longitudinal axis 306 is represented by a filled circle.

The housing 312 may be located about and partially enclose the shifting assembly 322. The housing 312 may have a flange 314. The flange 314 is positioned around the perimeter of an opening, such as a hole 318. The flange 314 may extend around perimeter of the hole 318. The flange 314 may be positioned radially around and encircle the hole 318. Surfaces of the flange 314 may extend in a radial direction from the perimeter of the hole 318. The hole 318 may be circular in shape, however it is to be appreciate that the hole 318 or another opening surrounded by a flange may be of another shape that may receive components of the shifting assembly 322, such as an elliptical shape, partially elliptical shape, a rectangular shape, irregular shape, etc. The shifting assembly 322 may be visible from a hole 318, such as via view 300. The hole 318 may be continuous and connected to a volume, such as a cavity, of the housing 312 that may house the shifting assembly 322. The hole 318 may be positioned in a first direction 326 from the shifting assembly 322. A cover 316 of the housing 312 may be positioned in a second direction 328 from the shifting assembly 322. The second direction 328 is opposite the first direction 326. The first direction 326 and second direction 328 may be a first longitudinal direction and a second longitudinal direction, respectively, wherein the first direction 326 and second direction 328 are parallel with the longitudinal axis 306. In the first view 300, the first direction 326 is represented by a filled circle, representing a direction into the first view 300. Likewise, in the first view 300, the second direction 328 is represented by an unfilled circle, representing a direction out of the first view 300. The first direction 326 and the second direction 328 are directions relative to the depth of the assembly 310 along the longitudinal axis 306. The cover 316 may be recessed relative to the flange 314, where the cover 316 is in the second direction 328 of the flange 314.

The flange 314 may fasten the housing 312 against a transmission or a component of the transmission, such that the housing 312 may be stable and an output of the shaft 308 may be drivingly coupled to a rotational element of the transmission. The cover 316 may prevent lubricant from leaving the housing in the second direction 328. For an example embodiment, the flange 314 may be fastened to a complementary surface, component, or feature of the transmission via a plurality of fasteners and complementary holes 320. The complementary holes 320 may extend through the material of the flange 314 and housing 312 in a longitudinal direction with respect to longitudinal axis 306.

The shifting assembly 322 may include a single or plurality of forks and a single or plurality of clutches and clutch components. For example, the shifting assembly 322 may comprise a first shift fork 324 and a first clutch assembly 332. The first shift fork 324 may be positioned outboard of the first clutch assembly 332. For an example of an embodiment, the first clutch assembly 332 may be a synchro clutch assembly, where the clutch includes a synchronizer. For an example of another embodiment, the first clutch assembly 332 may be a dog clutch assembly, where the clutch includes a dog clutch with dog teeth. The first shift fork 324 may be a cast shift fork for a transmission, wherein the first shift fork 324 is a unitary and singular component created through casting. For an example, the first shift fork 324 and first clutch assembly 332 may be the first arm 248 and first engagement 240, respectively, of FIG. 2. For another example, the first shift fork 324 and first clutch assembly 332 may be second arm 250 and second engagement 242, respectively, of FIG. 2. The first clutch assembly 332 may be coupled to the first shift fork 324, such that the first clutch assembly 332 may be actuated with the first shift fork 324. Likewise, a shifting rod, such as shifting rod 224 of FIG. 2, may couple to the first shift fork 324, such that the first shift fork 324 may be actuated in a longitudinal direction when the shifting rod slides in the longitudinal direction. The first clutch assembly 332 may selectively couple a gear of a gear assembly, referred to herein as a target gear. For example, a target gear may be the first gear 232 of FIG. 2. For another example, the target gear may be the third gear 236 of FIG. 2. When selectively coupled via the first clutch assembly 332, the target gear may be drivingly coupled to the shaft 308.

The first clutch assembly 332 may include a sleeve 334 and a first hub 336. The sleeve 334 may be located about the first hub 336, such as radially about the first hub 336. The sleeve 334 may encircle the first hub 336. The sleeve 334 may be a shift collar, such as a rotating shift collar. The first hub 336 may be located about the shaft 308, such as radially about the shaft 308. The first hub 336 may encircle the shaft 308. The sleeve 334 may be coupled to the first shift fork 324, such that the sleeve 334 slides longitudinally with the first shift fork 324. The sleeve 334 is a shift sleeve of the first clutch assembly 332. As a shift sleeve, sleeve 334 may be a clutch collar, such as a shift clutch collar.

For an example embodiment, the first shift fork 324 may be a unitary and singular component, comprised of features that are continuous with one another via casting. Alternatively, some components, such as a plurality of lobes, may be joined to the first shift fork 324. The first shift fork 324 may comprise an arched-shaped portion or feature, such as the supportive arch 342. The supportive arch 342 may have a curvature of a first radius 340. The supportive arch 342 connects to or includes a first arm 348 and a second arm 350. The supportive arch 342 connects to or includes a first cantilever 344 and a second cantilever 346. The centerline of the first cantilever 344 and the centerline of the second cantilever 346 may be parallel and approximately collinear. The first arm 348 and second arm 350 curve at an angle from and are approximately continuous with the curvature of the supportive arch 342. The first cantilever 344 and second cantilever 346 may extend from the supportive arch 342 toward the inner surfaces of the housing 312. The first cantilever 344 has an end on the opposite to the end of the second cantilever 346. The first shift fork 324 may be positioned such that the centerlines of the first cantilever 344 and second cantilever 346 are perpendicular to the longitudinal axis 306.

The first arm 348 and second arm 350 may have a first inner surface 349 and a second inner surface 351, respectively. The first inner surface 349 and second inner surface 351 may curve about and face toward the longitudinal axis 306 as well as portions of the first clutch assembly 332 and the shaft 308. The first inner surface 349 and second inner surface 351 may have a plurality of cast projections that extend in a perpendicular direction from each of the surfaces. The first shift fork 324 may have at least a pair of cast projections that may be used for lubrication. For example, a first cast projection, referred to herein as a first lobe 352, may extend from the first inner surface 349 toward the longitudinal axis 306. For this example, a second cast projection, referred to herein as a second lobe 354, may extend from the second inner surface 351 toward the longitudinal axis 306. The first and second lobes 352, 354 may be curved, such that the first and second lobes 352, 354 may curve about the shaft 308. The first and second lobes 352, 354 may be positioned outboard of the sleeve 334. The first and second lobes 352, 354 are structures, such as fins, that may direct work fluid away from the first inner surface 349 and second inner surface 351, respectively. For an alternative embodiment the first and second lobes 352, 354 may be joined to the first arm 348 and second arm 350, respectively.

The first arm 348 may terminate at and comprise a first mounting component 356. The second arm 350 may terminate at and comprise a second mounting component 358. The first and second mounting components 356, 358 may be partially cylindrical in shape. The first mounting component 356 may have a necking and a plurality of rounded surfaces and beveled surfaces continuous with the first arm 348. Likewise, the second mounting component 358 has a necking and a plurality of rounded and beveled surfaces continuous with the first arm 348 and a first target 362.

The first target 362 is a target for a position sensor, such that the position sensor may gauge the position of the first shift fork 324 along the axis 306. The first target 362 may be cast from or joined to the second arm 350. The first target 362 may extend from the second arm 350. An offset arm, may be cast from or joined to the second cantilever 346. The first target 362 may extend in a direction that is perpendicular to or radial with respect to the axis 306 when the first shift fork 324 is positioned about the axis 306. For example, in the first view 300, the first target 362 may extend in a lateral direction with respect to the axis 306. Likewise, an offset arm 360 may extend upward, in a vertical direction, from the second cantilever 346. Both the first target 362 and the offset arm 360 may extend toward the inner surfaces of the housing 312 from the first shift fork 324. The offset arm 360 may physically couple and actuatingly couple the first shift fork 324 to a shifting rod, such that the offset arm 360 may be actuated by the shifting rod.

The first shift fork 324 may physically couple to at least one body. The at least one body may be a structure that contacts the sleeve 334, such as when the first shift fork 324 is shifted in the first direction 326 or the second direction 328. The at least one body may transfer force of the first shift fork 324 to the sleeve 334, such that the sleeve 334 may be shifted in first direction 326 and second direction 328. The sleeve 334 may therein be shiftingly coupled to the first shift fork 324 via the at least one body. The at least one body may be an at least one shift fork pad. The at least one body may shiftingly couple the sleeve 334 to the first shift fork 324, such as when the at least one body physically couples to the first shift fork 324. The at least one body may include at least a passage, an inlet, and an outlet, via which a lubricant may be transported through. The lubricant may be oil. The passage of the at least one body may be a fluid passage and may be referred to additionally or alternatively herein as such. Likewise, the inlet and outlet of the fluid passage are complementary to the at least one body, wherein the at least one body and the fluid passage comprise the inlet and outlet. The inlet and outlet of the at least one body may be referred to additionally and alternatively herein as a complementary inlet and a complementary outlet for the at least one body. Lubricant may enter the at least one body outboard of the first shift fork 324 via the complementary inlet. Lubricant may exit the at least one body inboard the first shift fork 324 via the complementary outlet. It is to be appreciated a plurality of bodies, such as a pair of bodies may physically couple to the first shift fork 324.

For an example embodiment, a first body 372 may physically couple to the first mounting component 356, such as via being fastened to the first mounting component 356. Likewise, a second body 374 may physically couple to the second mounting component 358, such as via being fastened to the second mounting component 358. The first and second bodies 372, 374 are engagement devices, such as pads, for a clutch sleeve, such as sleeve 334. The first and second bodies 372, 374 may couple a clutch sleeve to a shift fork, such as shift coupling the sleeve 334 to the first shift fork 324. The first and second bodies 372, 374 may each be a shift fork pad for the first shift fork 324, where the first body 372 may be a first shift fork pad, and the second body 374 may be a second shift fork pad. The first body 372 may be positioned between the first mounting component 356 and the sleeve 334, and may have surface sharing contact with features of the sleeve 334. The second body 374 may be positioned between the second mounting component 358 and the sleeve 334, and have surface sharing contact with features of the sleeve 334. The surfaces of sleeve 334 in surface sharing contact with the first body 372 may comprise a first area of contact. The surfaces of the sleeve 334 in surface sharing contact with the second body 374 may comprise a second area of contact. The sleeve engagement region may comprise the first area of contact and the second area of contact. When in surface sharing contact with the sleeve 334, the first and second bodies 372, 374 may couple the sleeve 334 to the first shift fork 324, such that the sleeve 334 may be actuated with the first shift fork 324. When the first body 372 is fastened to the first mounting component 356, the first notch 364 and portions of the first lobe 352 may be positioned above the first body 372. Likewise, when the second body 374 is fastened to the second mounting component 358, the second notch 366 and portions of the second lobe 354 may be positioned above the second body 374. The first notch 364 and portions of the first lobe 352 may direct lubricant toward the first body 372. Likewise, the second notch 366 and portions of the second lobe 354 may direct lubricant toward the second body 374.

For an example, at least one of the first body 372 or the second body 374 has an internal passage, such as a channel, fluidly coupling an inlet and at least an outlet. The internal passage may be the fluid passage, the inlet may be the complementary inlet, and the outlet may be the complementary outlet described above. The inlet may receive lubricant and the outlet may expel lubricant from a respective body, where the respective body may be either the first body 372 or second body 374. The outlet may coat and lubricate the contact surfaces of the respective body with lubricant.

It is to be appreciated, that for this or other examples, there may be more than at least one body with a fluid passage, a complementary inlet, and a complementary outlet. Both the first body 372 and second body 374 may have a fluid passage with an inlet and at least an outlet. Each of the inlets may receive lubricant from a conduit and each of the outlets may expel lubricant from each of the respective bodies, (e.g., first and second bodies 372, 374). The first body 372 may have a first fluid passage, a first complementary inlet, and a first complementary outlet that may function as the fluid passage, complementary inlet, and complementary outlet, respectively, of the at least one body. Likewise, the second body 374 may have a second fluid passage, a second complementary inlet, and a second complementary outlet that may function as the fluid passage, complementary inlet, and complementary outlet, respectively, of the at least one body.

The sleeve 334 may have a plurality of teeth complementary to the first hub 336. The first hub 336 may be coupled with the sleeve 334, such as to slide longitudinally with the sleeve 334. The sleeve 334 may be complementary to an engagement feature, such as a gear collar, of a target gear, such that the sleeve 334 may engaged and selectively couple to the engagement feature. The engagement feature may be drivingly coupled to the target gear, therein the sleeve 334 may selectively and rotationally couple to the target gear via the engagement feature. For example, the sleeve 334 may have teeth complementary to the teeth of the gear collar of the target gear. When the teeth of the sleeve 334 and teeth of the gear collar engage, the sleeve 334 may selectively and rotationally couple with the gear collar. By extension, the engagement of the sleeve 334 with the gear collar may selectively and rotationally couple the first clutch assembly 332 to the target gear. The gear collar may be a coupling, such as the first coupling 244 or second coupling 246 of FIG. 2.

Turning to FIG. 3B, it shows the first view 300 of the assembly 310 positioned about a longitudinal axis 306, where the assembly 310 includes a lubrication distribution system of the present disclosure. The lubrication distribution system includes at least a pump 382, one or more conduits, at least one mounting component, and at least one body, where the at least one body includes a fluid passage, an at least one inlet, and an at least one outlet. The at least one mounting component and the at least one body may be complementary the conduit, such as to receive work fluid from and be fluidly coupled to the conduit. The first shift fork 324 is compatible with the distribution system, such as to be internally lubricated, where lubricant may be delivered from the outboard to the inboard of the first shift fork 324. The first shift fork 324 may include the at least one mounting component. The at least one body may physically couple to the first shift fork 324 via the at least one mounting component. The at least one mounting component of the lubrication distribution system has a through fitting, such as a passage, that the complementary body may receive lubricant from. The at least one mounting component may include at least the first mounting component 356 or the second mounting component 358. Likewise, the at least one complementary mounting component may include either the first mounting component 356 or the second mounting component 358. The at least one body may receive lubricant via the at least one inlet and expel lubricant via the at least one outlet, where the at least one inlet and the at least one outlet are in fluid communication via the fluid passage. Lubricant may enter the inlet from outboard of the first shift fork 324. Lubricant may exit the outlet inboard of the first shift fork 324. The outlet may coat and lubricate the contact surfaces of the complementary body with lubricant. The at least one body of the lubrication distribution system may include at least the first body 372 or the second body 374. However, it is to be appreciated that the lubrication distribution system may include a plurality of conduits, a plurality of mounting components, and a plurality of bodies complementary to the mounting components and that may shift couple the sleeve 334 to the first shift fork 324. Each of the plurality of mounting components may receive a body of the plurality of bodies via a fit, where the fit may be a passage such as a through passage, and the fit may receive lubricant from one of the plurality of conduits. Each of the plurality of bodies may include a complementary fluid passage, a complementary inlet, and at least a complementary outlet, where the complementary inlet and complementary outlet may be fluidly coupled via the complementary fluid passage. For an example of an embodiment, there may be a pair of complementary mounting components of the lubrication distribution system, including the first and second mounting components 356, 358. Likewise, there may be a pair of complementary bodies of the lubrication distribution system including the first and second bodies 372, 374. Likewise, it is to be appreciated that there may be a plurality of outlets fluidly coupled to an inlet via a fluid passage for the at least one body or the plurality of bodies.

In FIG. 3B, the assembly 310 includes a pump 382 and a plurality of conduits. For an example of an embodiment, the assembly 310 and lubricant distribution system includes a pair of conduits, including a first conduit 384 and a second conduit 386. The pump 382 may rest upon a feature of the housing 312 such as a platform 380. However, the pump 382 may rest upon, affix to, or mount to another feature of the housing 312 or a stationary feature of the assembly 310, such that the pump 382 may be fixed. The assembly 310 may have a sump 392 that may collect work fluid from lubricated components of the assembly 310. The sump 392 may be part of housing 312, such as the lower part of the housing 312. The pump 382 may be communicatively coupled with a controller 378. Communication and communicative coupling between the controller 378 and the pump 382 may be represented by a dash dotted line 379 with arrows on opposite ends. The sump 392 may collect a work fluid that is a lubricant, such as oil. The pump 382 may uptake lubricant from the sump 392 via suction generated by the pump. The controller 378 may send command signals to increase the suction of the pump 382. The controller 378 may be the controller 156 or another controller part of the control system 154 of FIG. 1. The controller 378 may be in communication with a plurality of sensors, such as sensors 158 of FIG. 1. The controller 378 may send command signals such that the pump 382 uptakes and pressurizes fluid continuously, such as when the vehicle 100 of FIG. 1 is running. The controller 378 may send command signals such that the pump 382 uptakes and pressurizes fluid during a shift event, such as when the first clutch assembly 332 closes and the sleeve 334 engages with an engagement component of a rotational element, such as a gear.

The sensors in communication (e.g., communicatively coupled) with the controller 378 may send signals to the controller 378 of a shift event. The sensors may send signals to the controller 378 of the rotational speed of the shaft 308. Likewise, the sensors may send signals to the controller 378 of rotational speed of movers drivingly coupled to the assembly 322, such as the prime mover 106 and/or other movers of the vehicle 100 in FIG. 1. Signals from the sensors in communication with the controller 378 indicating a rotational speed above a threshold may be used to increase flowrate of lubricant to and out of the pump 382. Increased suction from the pump 382 may increase the flowrate of lubricant up-taken by the pump 382 from the sump 392. Increased pressure output by pump 382 may increase the flowrate and pressure of lubricant out of the pump 382. The controller 378 may send a command signal to increase suction from and pressure output by the pump 382. The command may increase flowrate of lubricant from the sump 392 to the pump 382, and may increase the flowrate out of the pump 382. The pump 382 may be an oil pump for pressurizing oil, and the pump 382 may be connected to one or more oil conduits. The first conduit 384 may be a first oil conduit, and the second conduit 386 may be a second oil conduit.

The pump 382 may have at least an inlet on the suction side and a plurality of outlets on the pressure side. For example, the pump 382 may have an inlet 398, a first outlet 394, and a second outlet 396. The first conduit 384 may extend from the first outlet 394 to the first mounting component 356. The second conduit 386 may extend from the second outlet 396 to the second mounting component 358. The first conduit 384 may fluidly couple and fluidly seal to the first outlet 394. The first conduit 384 may fluidly couple to the first mounting component 356 and the first body 372. The first outlet 394 may fluidly couple to the first mounting component 356 and first body 372 via the first conduit 384. The second conduit 386 may fluidly couple and fluidly seal to the second outlet 396. The second conduit 386 may fluidly couple to the second mounting component 358 and the second body 374. The second outlet 396 may fluidly couple to the second mounting component 358 and second body 374 via the second conduit 386. The sump 392 may fluidly couple the suction side of the pump 382 via the inlet 398. The sump 392 may fluidly couple to the pump 382, such as directly via the inlet 398. Additionally, or alternatively, the sump 392 may fluidly couple to the pump 382 via a conduit in fluid communication with the inlet 398.

Lubricant may be up-taken from the sump 392 via the suction of the pump 382 along a flow path 393. Lubricant may enter the pump 382 via the inlet 398 along flow path 393. When up-taken from the flow path 393, the sump 392 may pressurize and divide lubricant to be driven along a first flow path 388 and/or a second flow path 390. As an oil pump, the pump 382 may uptake oil from the sump 392, pressurize oil, and expel oil via the first outlet 394 and/or second outlet 396. The pump 382 may divide oil to be driven along the first flow path 388 and/or a second flow path 390.

Lubricant carried by the first flow path 388 may exit the pump 382 via the first outlet 394 and be driven through the first conduit 384. The first flow path 388 may deliver lubricant to the first mounting component 356 and the first body 372. Lubricant may pass through the first mounting component 356 and the first body 372 via the first flow path 388. Lubricant may lubricate the first body 372 and be delivered to the sleeve 334 from the first body 372 via the first flow path 388. Lubricant carried by the second flow path 390 may exit the pump 382 via the second outlet 396 and be driven through the second conduit 386. The second flow path 390 may deliver lubricant to the second mounting component 358 and the second body 374. Lubricant may pass through the second mounting component 358 and the second body 374 via the second flow path 390. Lubricant may lubricate the second body 374 and be delivered to the sleeve 334 from the second body 374 via the second flow path 390. Lubricant on the first and second flow paths 388, 390 may be returned to the sump 392 from the sleeve 334, such as via being flung, dripped, or splashed from the sleeve 334. It is to be appreciated that after leaving contact with the sleeve, lubricant delivered via the first and/or second flow paths 388, 390 may be sent to other components of the assembly 310 before returning to the sump 392.

A method of lubricating the sleeve 334 via the shift fork may comprise pressurizing lubricant via the pump 382, and expelling lubricant from the pump 382 via the first flow path 388 or second flow path 390, using the respective components and features complementary to the first flow path 388 or the second flow path 390. Respective features may include an outlet of the pump, a respective conduit, at least one body, and a respective inlet and a respective outlet of the at least one body. For the first flow path 388, the pump outlet may be the first outlet 394, the respective conduit may be the first conduit 384, the one body may be the first body 372, the respective inlet may be the first inlet of the first body 372, and the respective outlet may be the first outlet of the first body 372. For the second flow path 390, the pump outlet may be the second outlet 396, the respective conduit may be the second conduit 386, the one body may be the second body 374, the respective inlet may be the second inlet of the second body 374, and the respective outlet may be the second outlet of the second body 374. For the method, lubricant lubricates a complementary surface of the one body, where the first surface is contiguous with and fluidly coupled to the respective outlet. The complementary surface may include a first surface of the first body 372 for the first flow path 388. The complementary surface may include a second surface of the second body 374 for the second flow path 390. Lubricant contacts and lubricates at least a feature of the sleeve 334, such as a surface of the sleeve 334. The first surface of the first body 372 and the surface of the sleeve 334 may have surface sharing contact. Likewise, the second surface of the second body 374 and the surface of the sleeve 334 may have surface sharing contact.

Another method of lubricating the sleeve 334 includes pressurizing lubricant via the pump 382, and expelling lubricant from the pump 382 via the first flow path 388 and the second flow path 390, using the respective components and features complementary to the first flow path 388 and the second flow path 390.

For an example, the pump 382 may be a mechanical pump. For another example, the pump 382 may be an electric pump. Whether mechanical or electrical, the pump 382 may be the first pump 266 or the second pump 268 of FIG. 2. Likewise, the sump 392 may be the sump 228 of FIG. 2. For an example, one or more of the first conduit 384 and/or the second conduit 386 may be a flexible conduit, such as a flexible tube or a hose. For this or other examples, one or more of the first conduit 384 and/or the second conduit 386 may be a rigid conduit, such as a rigid tube or a pipe. It is to be appreciated, that the pump 382, the first conduit 384, the second conduit 386, the first flow path 388, the second flow path 390, and flow path 393 are drawn schematically and may have relative positioning.

Turning to FIG. 4A, it shows a second view 400 of the assembly 310 positioned about a longitudinal axis 306. The second view 400 is a side view of the assembly 310, and none of the reference axes 301 are normal to a plane the second view 400 is taken on.

The second view 400 shows an end 422 of the shaft 308. The end 422 may be an input or an output. The end 422 may support and drivingly couple to a rotational element, such as a gear, such as an input or output gear to the shifting assembly 322 and shaft 308. The end 422 may be rigidly connected to the shaft 308. A gap 423 between the end 422 and shaft 308 may be a transition region of the shaft 308. The transition region of the shaft 308 comprising the gap 423 may not be splined. Likewise, the second view 400 shows a first gear collar 410 and a second hub 412. The first gear collar 410 and second hub 412 may be positioned between the first shift fork 324 and a second shift fork 414. The first clutch assembly 332 may comprise and be engage with the first gear collar 410. The first gear collar 410 may have a plurality of teeth that may be complementary to and mesh with the sleeve 334. Likewise, a second clutch assembly may shiftingly couple to the second shift fork 414. The second shift fork 414 may be positioned outboard of the second clutch assembly. The second clutch assembly may comprise and be supported by a second hub 412. The second clutch assembly may also comprise a structure 416. A second sleeve 417 may be slidingly coupled to and housed by the structure 416. The second sleeve 417 may be a shift collar, such as a rotating shift collar. When slidingly coupled, the second sleeve 417 may slide when housed by the structure 416 while the structure remains stationary. The second sleeve 417 may shiftingly couple to the second shift fork 414. The second hub 412 may have a plurality of splines and/or teeth complementary to the splines of the sleeve of the structure 416.

The second shift fork 414 may be a shift fork of approximately the same configuration as the first shift fork 324, wherein the second shift fork 414 may have approximately the same dimensions and features as the first shift fork 324. The second shift fork 414 may be positioned about the components such as the shaft 308 and components of the second clutch assembly. The second shift fork 414 may be shiftingly coupled to a second sleeve housed within the structure 416. The second sleeve may have approximately the same dimensions as the sleeve 334. The second shift fork 414, structure 416, and second sleeve 417 may be positioned about the shaft 308 longitudinally between the first shift fork 324 and the cover 316. In second view 400, the first direction 326 and second direction 328 may be represented by arrows.

The second shift fork 414 may be mirrored and flipped compared to the first shift fork 324 with respect to the longitudinal axis 306. For example, the second shift fork 414 may have a second target 426 for a second position sensor. The second target 426 may be an appendage that extends from an arm of the second shift fork 414. The second target 426 may be positioned to have a length 427 perpendicular to the axis 306 and parallel with an axis 455, when the second shift fork 414 is positioned about the axis 306. The second target 426 may have approximately the same dimensions as the first target 362. The second target 426 may extend toward the opposite side of the housing 312 from the side of the housing 312 the first shift fork 324, with respect to the longitudinal axis 306. The second target 426 may extend toward and through an inner surface 424 of the housing 312. The housing 312 may have a second inner surface on the opposite side of the longitudinal axis 306 from the inner surface 424. Like the second target 426 with the inner surface 424, the first target 362 of first shift fork 324 may extend toward and through an inner surface of the housing 312 opposite to the inner surface 424.

The second shift fork 414 may physically couple to at least a body, such as a shift pad, where the shift pad may shiftingly couple the second shift fork 414 to the second sleeve. The second shift fork 414 may physically couple to a plurality of bodies, such as a pair of bodies, where the bodies may be shift pads. The bodies complementary to the second shift fork 414 may mirror and be of the same dimensions as the first and second bodies 372, 374.

The second shift fork 414 may be complementary to a lubrication distribution system of the present disclosure such as to be internally lubricated. Lubricant may be delivered from outboard to inboard the first shift fork 324 via the lubrication system. The lubrication distribution system includes at least a pump, at least a conduit, at least a complementary mounting component, and at least a complementary body. The second shift fork 414 may include the complementary mounting component, and the second shift fork 414 may physically couple to the body. The complementary mounting component of the lubrication distribution system has a through fitting, such as a passage. The passage may be complementary to a body such as to receive a body, and the passage and the body may receive lubricant from the conduit via the passage. The body has a fluid passage including an inlet and at least an outlet that are complementary to the body, wherein the fluid passage, the complementary inlet, and the complementary outlet are included by the body. The fluid passage may be internal to the body. The complementary inlet may receive lubricant and the complementary outlet may expel lubricant from the body. Lubricant may be pressurized by the pump and transported via the conduit to the complementary inlet. The complementary outlet may coat and lubricate the contact surfaces of the body with lubricant. However, it is to be appreciated that the lubrication distribution system may include a plurality of conduits, a plurality of mounting components, and a plurality of bodies. The lubrication distribution system may lubricate the second sleeve 417 via the second shift fork 414.

The second target 426 may extend from the second shift fork 414 toward a first recess 428 of the housing 312. A region 430 may comprise the recess 428 and the second target 426. The region 430 may also comprise portions of the inner surface 424 and other components of the first and second shift forks 324, 414. The region 430 may be enclosed by a plurality of dashed lines. The recess 428 may comprise and be depressed into the inner surface 424. The recess 428 may be positioned about portions of the second target 426. The second shift fork 414 may be mounted, such that the second target 426 may not rest upon and/or be in surface sharing contact with the walls of the recess 428. When shifted, the second shift fork 414 may move the second target 426 in a longitudinal direction within the walls of the recess 428.

The sleeve 334 has a first groove 442. The first groove 442 may be flanked by a first wall 444 and a second wall 446. The first wall 444 and the second wall 446 may be located radially, with respect to the longitudinal axis 306, and comprise the circumference of the sleeve 334. The first groove 442 may depress through the material of sleeve 334. The first groove 442 may depress in a radial direction with respect to the longitudinal axis 306 about the circumference of the sleeve 334. The first body 372 may be positioned in and partially enclosed by the first groove 442, such as when the first body 372 is fastened to the first mounting component 356. The first body 372 may be flanked by and in surface sharing contact with the first wall 444 and second wall 446, such as when the first body 372 is fastened to the first mounting component 356. Likewise, the second body 374 may be positioned in and partially enclosed by the first groove 442, such as when the second body 374 is fastened to the second mounting component 358. The second body 374 may be flanked by and in surface sharing contact with the first wall 444 and second wall 446, such as when the second body 374 is fastened to the second mounting component 358. The first body 372 and/or the second body 374 may make surface sharing contact with surfaces of the first groove 442. When the first and second bodies 372, 374 are inserted to the first groove 442 and fastened to the first mounting component 356 and second mounting component 358, respectively, the sleeve 334 may shiftingly couple to the first shift fork 324. The sleeve 334 and first clutch assembly 332 may rotate and spin about the longitudinal axis 306 when drivingly coupled to the first shift fork 324.

The first body 372 may be fastened to the first mounting component 356 via a first fastener 452. Likewise, the second body 374 may be fastened to the second mounting component 358 via a second fastener 454.

Portions of the first body 372 may be inserted through a first complementary fit and a second groove 460. The second groove 460 may have surfaces about, supporting, and in surface sharing contact with the first body 372. The first body 372 may be fastened to the first mounting component 356, such as when an appendage (e.g., see second appendage 456) of the first body 372 is inserted into the first fit of the first mounting component 356, and the first fastener 452 is inserted into a second complementary hole of the first mounting component 356. The appendage of the first body 372 may be a stem: a supportive section of the first body 372 that is thinner relative to the pad or pad section of the first body 372. The appendage of first body 372 may be received by a first opening of the first fit, where the first opening faces the second groove 460. The first opening may be a hole. The first fit may be a through passage extending between opposite sides of the first mounting component 356. The first fastener 452 may prevent slipping or other movement of the first body 372 along the axis 455.

Portions of the second body 374 may be inserted through a second fit 458 and a third groove 462 of the second mounting component 358. The second fit 458 may be a through passage. The third groove 462 may have surfaces about, supporting, and in surface sharing contact with the second body 374. The second body 374 may be fastened to the second mounting component 358, such as when a second appendage 456 of the second body 374 is inserted into the second fit 458 of the second mounting component 358, and the second fastener 454 is inserted into a fourth complementary hole of the second mounting component 358. The second appendage 456 of the second body 374 may be a stem like the first appendage of the first body 372. The second appendage 456 may be received by a second opening of the second fit 458, where the second opening faces the third groove 462. The second opening may be a hole. The second fastener 454 may prevent slipping or other movement of the second body 374 along the axis 455. The axis 455 may be lateral and perpendicular to the longitudinal axis 306.

The axis 455 may be concentric to a plurality fits complementary of the first mounting component 356 and second mounting component 358, such as the first fit and second fit 458. The first fit and second fit 458 may be of the same dimensions, where the first fit on the first mounting component 356 may mirror the second fit 458 on the second mounting component 358. Likewise, the second groove 460 may mirror the third groove 462.

The first appendage of the first body 372 may have a first inlet. The second appendage 456 may have a second inlet 464. Lubricant may be passed through the first body 372 via the first inlet and the second body 374 via the second inlet 464. The first inlet and second inlet 464 may be openings, such as holes. The first inlet of the first body 372 may share the same dimensions and mirror the second inlet 464. The first fit of the first mounting component 356 and first inlet of the first body 372 may be complementary and fluidly couple to a conduit that transports lubricant, such as the first conduit 384 of FIG. 3B. The second fit 458 and second inlet 464 may be complementary and fluidly couple to a conduit that transports lubricant, such as the second conduit 386 of FIG. 3B. The first fit and first inlet may receive lubricant from the first conduit 384. Lubricant from the first conduit 384 may lubricate the first body 372 via the first fit and the first inlet. The second fit 458 and the second inlet 464 may receive lubricant from the second conduit 386. The lubricant from the second conduit 386 may lubricate the second body 374 via the second fit 458 and the second inlet 464.

The end 422 may have a plurality of splines 472 that may be complementary to a gear, such as the input gear or output gear described above, or another rotational element. Likewise, the shaft 308 may have a plurality of splines 474 that may be complementary to a plurality of splines or teeth of the first clutch assembly 332. The sleeve 334 may have a plurality of teeth 476. The teeth 476 may be complementary to a plurality of splines 478 of the first hub 336.

As the sleeve 334 rotates, friction may be generated between the surfaces of the groove 442, the first wall 444, and second wall 446 and the first body 372 and second body 374. To reduce the buildup of thermal energy and the friction on the surfaces of the sleeve 334, the first body 372, and the second body 374, lubricant may be supplied to the sleeve 334, the first body 372, and the second body 374 via features of the first shift fork 324 and the lubricant distribution system described in FIG. 3B. The supportive arch 342, first lobe 352, and second lobe 354 may collect and direct lubricant toward the first and/or second bodies 372, 374. Likewise, lubricant transported via the lubricant system may coat and lubricate the first and/or second bodies 372, 374. Lubricant may be transported to the inlets of the first and/or second bodies 372, 374. Lubricant may be transported through the first and/or second bodies 372, 374 to exit at least one outlet of the first body 372 and at least one outlet of the second body 374. Lubricant exiting the at least one outlet of the first body 372 may lubricate the contact surfaces of the first body 372 and sleeve 334. Lubricant exiting the at least one outlet of the second body 374 may lubricate the contact surfaces of the second body 374 and sleeve 334. Lubricant may exit the outlets of the first body 372 and/or second body 374 to lubricate the contact surfaces extending from the outlets of the first body 372 and/or second body 374. Lubricant may outlets of the first body 372 and/or second body 374 to lubricate the first groove 442. For example, lubricant may enter the second inlet 464 via the second fit 458. From the second inlet 464, lubricant may be transported through the second body 374 via an internal passage. The internal passage may fluidly couple the second inlet to at least one outlet. The at least one outlet may be an opening on a contact surface of the second body 374. The contact surface may make surface sharing contact with at least a surface of the sleeve 334, including one or more surfaces of the first groove 442, the first wall 444, and/or the second wall 446. Lubricant exiting the at least one outlet may coat the contact surface complementary to the at least one outlet and a plurality of other contact surfaces of the second body 374, lubricating both the second body 374 and the first groove 442. Additionally or alternatively, the second body 374 may have a plurality of outlets, with each of the plurality of outlets being openings complementary to other contact surfaces separate from the contact surface of the at least one outlet of the second body 374.

Turning to FIG. 4B, it shows a view 490 of the region 430. View 490 shows a position sensor 492. The position sensor 492 may estimate the position of the second target 426 in the recess 428 with respect to an axis parallel with axis 306. The position sensor 492 may estimate the change in position from a point along an axis parallel with axis 306 in the first direction 326 or second direction 328. Data of the position of the second target 426 may be used by a controller, such as the controller 378 of FIG. 3B or the controller 156 of FIG. 1, and/or computer processor communicatively coupled to the position sensor 492 to estimate the position of the second shift fork 414. As an example, the position sensor 492 may measure a distance 498. The distance 498 may be between a first surface 494 of the position sensor 492 and a second surface 496 of the second target 426. The distance of distance 498 may be variable and change as the second target 426 is actuated with the second shift fork 414.

A second position sensor of the same type as position sensor 492 may be used to measure the position of the first target 362 as it moves in a complementary recess opposite to the recess 428 across the axis 306. The second position sensor may measure the position of the first target 362 in a similar process to how position sensor 492 may measure the second target 426 as described above. The second position sensor may be communicatively coupled to a controller and/or computer processor. Data from the second position sensor may be used by the controller and/or computer processor to estimate the position of the first shift fork 324.

Turning to FIG. 5 it shows a third view 500 of a body 512. The body 512 may be an embodiment of a body complementary to the assembly 310 of FIG. 3A. For example, the body 512 may be an embodiment of the first body 372 and/or the second body 374 of FIG. 3A. The third view 500 is a side view of the body 512, wherein the body 512 is isolated from other components of the assembly 310. The body 512 may have a first side 504 and a second side 506, where the first side 504 is opposite to the second side 506. The body 512 may have a third side 505 and a fourth side 507, where the third side 505 is opposite to the fourth side 507. The body 512 may be positioned about a first axis 508 and a second axis 510. The first axis 508 may be a longitudinal axis, relative to and for the body 512. The second axis 510 may be a lateral axis, relative to and for the body 512. However, it to be appreciated that the first axis 508 may be parallel or collinear with the axis 455 of FIG. 4A, and therein the first axis 508 may be a lateral axis relative to the assembly 310. Likewise, it is to be appreciate that the second axis 510 may be parallel with the longitudinal axis 306 of FIG. 3A, and therein the second axis 510 may be a longitudinal axis relative to the assembly 310. The body 512 may be centered about the first axis 508.

The body 512 includes a feature that may be a shift fork pad, a sleeve pad, and an oil pad. The body 512 may include a pad section 514 and an appendage section 516. The appendage section 516 is an appendage, such as a stem, extending toward the second side 506 from the pad section 514. The appendage section 516 may be a stem that is partially cylindrical in shape. The appendage section may be centered about the first axis 508, such as to be positioned radially around the first axis 508. The pad section 514 may comprise a pad. The pad section 514 may engage and make surface sharing contact with an engaging sleeve of a clutch, such as sleeve 334 of FIG. 3A. The appendage section 516 may couple to a mounting component of a shift arm, such as the first mounting component 356 or the second mounting component 358 of FIG. 3A. The appendage section 516 may be received by a fit of a mounting section, such as the second fit 458 of FIG. 4A.

The body 512 may be divided by a first line 518 and a second line 520. Both the first line 518 and the second line 520 may divide the body 512 into approximately symmetrical sections. The first line 518 and the second line 520 are perpendicular. A line parallel with the z axis of the reference axes 301 may be normal to a plane taken on the first line 518. A line parallel with the y axis of the reference axes 301 may be normal to a plane taken on the second line 520. A sectional view may be taken on the first line 518 in FIG. 6 below. A sectional view may be taken on the first line 518 in FIG. 7 below.

The pad section 514 may comprise a plurality of combined rectangular volumes, such as rectangular parallelograms. The pad section 514 may comprise a plurality of surfaces that are rectangular or other polynomials that are irregular with angular corners. The pad section 514 has a first surface 522, a second surface 524, a third surface 526, a fourth surface 528, and a fifth surface 530 that may be rectangular in shape. The second surface 524 may be semi-rectangular in shape. The first surface 522 is on the first side 504. The second surface 524 is on the third side 505. The pad section 514 may have a surface mirroring the second surface 524 that is on the fourth side 507. The third surface 526 is on the second side 506. The fourth surface 528 is at the top and the fifth surface 530 is at the bottom of the pad section 514. The appendage section 516 may extend toward the second side 506 from the third surface 526. The first surface 522 and second surface 524 may be contact surfaces that may be in surface sharing contact with complementary features of an engaging sleeve, such as with the groove 442, first wall 444, and second wall 446 of FIG. 4A. The first surface 522, the second surface 524, the third surface 526, the fourth surface 528, and the fifth surface 530 may be contiguous with each other and other surfaces of the pad section 514 via a plurality of straight or angled edges.

The appendage section 516 may include a plurality of cylindrical and semi-conical volumes, and a plurality of cylindrical, circular, and semi-conical surfaces. The appendage section 516 may comprise a plurality of cylindrical and semi-conical volumes, and a plurality of cylindrical, circular, and semi-conical surfaces. The appendage section 516 may have a first outer surface 532 and a second outer surface 534. The first outer surface 532 may be curved, such as to curve about the first axis 508, where the first outer surface 532 may curve around the first axis 508. The first outer surface 532 may be cylindrical shaped and may curve radially about the first axis 508. The first outer surface 532 may curve around the appendage section, such as for an example to encircle the appendage section 516. The second outer surface 534 may be flat and normal to first axis 508. The second outer surface 534 may have a circular perimeter/edge. The second outer surface 534 may be ring like in shape, where the surface may extend radially outward from a first opening 542.

The body 512 includes the first opening 542 and a second opening 544 that are visible via the third view 500. The appendage section 516 includes the first opening 542 and the pad section 514 includes the second opening 544. The appendage section 516 includes at least an inlet and the pad section 514 includes at least one outlet, (e.g., an oil inlet and an oil outlet respectively). The first opening 542 may be an inlet of the appendage section 516. The second opening 544 may be an outlet of the pad section 514, such as the at least one outlet. The first opening 542 may be the second inlet 464 of FIG. 4A. The second outer surface 534 includes the first opening 542, and therein the second outer surface 534 may be may be an inlet face. The perimeter of the first opening 542 may be contiguous and flush with the second outer surface 534. The second surface 524 may include the second opening 544, and therein the second surface 524 may be an outlet surface. The perimeter of the second opening 544 may be contiguous and flush with the second surface 524. The first and second openings 542, 544 may each be elliptical in area with elliptical perimeters. For an example of an embodiment, the first and second openings 542, 544 may each be circular in area with circular perimeters. For an example embodiment of the body 512, the body 512 has one outlet. The one outlet may be the second opening 544. For another example embodiment of the body 512, the body 512 has a plurality of outlet, such as a pair of outlets. Another opening that is an outlet may mirror the second opening 544, where the other opening is contiguous and flush with a surface on the fourth side 507.

The surfaces of the pad section 514 may be connected and contiguous via a plurality of chamfers and other surface features that may be flat. Surfaces of the appendage section 516 may include chamfers and other surfaces that may curve around the first axis 508. The pad section 514 and the appendage section 516 may be connected and continuous via surfaces that are curved and have non-linear slopes. For an example of an embodiment of the pad section 514, the second surface 524 may be connected to and contiguous with the fourth surface 528 via a first chamfer 552. The second surface 524 may be connected to and contiguous with the fifth surface 530 via a second chamfer 554, respectively. The first and second chamfers 552, 554 may be flat surfaces of a linear slope. The first and second chamfers 552, 554 may have surface areas that are irregular polynomials in shape. The third surface 526 may be connected and contiguous with the fourth surface 528 via a third chamfer 556. The third surface 526 may be connected to and contiguous with the fifth surface 530 via a fourth chamfer 558. The third and fourth chamfers 556, 558 may be flat surfaces of a linear slope. The third and fourth chamfers 556, 558 may have areas that are rectangular in shape. The second surface 524 may have a section 560 that is triangular in shape and extends toward the second side 506. The third surface 526 may be connected to and continuous with the first outer surface 532 via a fillet 562. The first outer surface 532 may be connected to and contiguous with the second outer surface 534 via a fifth chamfer 564. The fifth chamfer 564 may be a surface that is frustoconical in shape and curves around the first axis 508. The first outer surface 532 may be connected to and contiguous with the fillet 562 via the section 560.

Turning to FIG. 6, it shows a fifth view 600 of the body 512. The fifth view 600 is a sectional view of the body 512 that may be taken on the second line 520 of FIG. 5.

The fifth view 600 shows an example of the body 512 may be a unitary structure comprised of a material 610. The material 610 is continuous and solid, common to both the pad section 514 and the appendage section 516. The material 610 may be continuous through the pad section 514 and the appendage section 516. As a unitary structure, the material 610 may be molded or machined into the shape of the body 512. However, it is to be appreciated that for other examples the body 512 may not be unitary. For an alternative embodiment, the pad section 514 and the appendage section 516 may be separate components physically coupled together, such as via joining.

The body 512 may have a plurality of passages that extend through the material 610. The body 512 may include a first passage 612 and a third passage 614. The first passage 612 may extend through material 610 along the first axis 508, where the first passage 612 may be positioned around the first axis 508. The first passage 612 may be centered about the first axis 508. The third passage 614 may extend through material 610 along the second axis 510, where the third passage 614 may be positioned around the second axis 510. The third passage 614 may be centered about the second axis 510. The first passage 612 may have surfaces that curve about the first axis 508, such as surfaces that curve around and/or encircle the first axis 508. The first passage 612 may have surfaces that are cylindrical and conical. Likewise, the first passage 612 may have volumes that are cylindrical and conical. The third passage 614 may include surfaces that curve about the second axis 510, such as surfaces that may curve around and/or encircle the second axis 510. The third passage 614 may include surfaces and volumes that are cylindrical in shape.

The first passage 612 may fluidly couple to the first opening 542. The surfaces of the first passage 612 may be continuous with the perimeter of the first opening 542. The third passage 614 may fluidly couple a third opening 622. The surfaces of the third passage 614 may be continuous with the perimeter of the third opening 622. The third opening 622 may be elliptical in area with an elliptical perimeter. For an example of an embodiment, the third opening 622 may be circular in area with a circular perimeter. The third opening 622 may mirror the second opening 544 of FIG. 5. Like the second opening 544, the third opening 622 may be an outlet.

The first passage 612 may include a sink 632. The sink 632 may be at an end of the first passage 612 opposite to the first opening 542. The sink 632 may have a conical surface that may curve about the first axis 508. The surface of the sink 632 may encircle, decrease in diameter toward, and terminate at the first axis 508. The sink 632 may have a conical volume at a sink 632. The third passage 614 may have a cylindrical volume.

Turning to FIG. 7, it shows a sixth view 700 of the body 512. The sixth view 700 is a sectional view of the body 512 that may be taken on the first line 518 of FIG. 5.

The sixth view 700 shows the body 512 may include a second passage 714. The second passage 714 may extend through material 610 along the second axis 510, where the second passage 714 may be positioned around the second axis 510. The second passage 714 may be centered about the second axis 510. The second passage 714 may include surfaces that curve about the second axis 510, such as surfaces that may encircle the second axis 510. The second passage 714 may include surfaces and volumes that are cylindrical. The second passage 714 may fluidly couple the second opening 544. The surfaces of the second passage 714 may be continuous with the perimeter of the second opening 544.

For embodiments of the body 512 including only one outlet, there may be only one passage fluidly coupling the first passage 612 to the one outlet. For a first example embodiment, where the second opening 544 is the one outlet, the body 512 may include the second passage 714 but not the third passage 614. For another example embodiment, where the third opening 622 is the one outlet, the body 512 may include the third passage 614 but not the second passage 714.

The sixth view 700 shows the body 512 may have a sixth chamfer 722. The first surface 522 may be connected to and contiguous with the second surface 524 via the sixth chamfer 722. The sixth chamfer 722 may have a flat surface with a linear slope. The sixth chamfer 722 may have an area that is an irregular polynomial in shape.

The sixth view 700 shows a flow path 732 that a lubricant may take through the body 512. The flow path 732 may start at the first opening 542, where lubricant may enter the first passage 612. Lubricant may continue along the first passage 612 toward the first side 504 to the sink 632. At the sink 632, lubricant and the flow path 732 may be split. The flow path 732 may split into a first sub path 734a and a second sub path 734b. Lubricant may travel through the second passage 714 along the first sub path 734a toward the third side 505. Lubricant may exit the second passage 714 via the second opening 544. Lubricant that exits the second opening 544 may coat and lubricate the second outer surface 534 and other surfaces on the third side 505. Lubricant may travel through the third passage 614 along the second sub path 734b toward the fourth side 507. Lubricant may exit the third passage 614 via the third opening 622. Lubricant that exits the third opening 622 may coat and lubricate surfaces on the fourth side 507, such as a surface mirroring the second surface 524.

In this way, a lubrication distribution system may lubricate a sleeve and other component of a clutch assembly via a shift fork that is internally lubricated. Lubricant may be provided and placed in fluid communication with the shift fork via a lubrication system, including a pump and a plurality of conduits. The lubricant may internally lubricate the shift fork via bodies and fitting complementary to the bodies. Lubricant, such as oil, may be supplied to lubricate the bodies via the lubrication system, where the conduits fluidly couple to the sleeve engagements. For an example embodiment, the body is a shift pad. Each sleeve engagement has at least a fluid passage fluid passage with at least an inlet for receiving work fluid and at least an outlet for lubricating contact surfaces of the body. The body may have a plurality of outlets, such as two outlets for an example embodiment of the body, where each of the two outlets has a perimeter and surface contiguous with a contact surface of the body.

In another representation, a system comprising: a pump; one or more conduits connected to the pump; and at least one body coupled to a shift arm for engaging a sleeve, where the at least one body comprises an inlet connected to a conduit from the one or more conduits, at a first outlet, a second outlet, and an internal passage being in fluid communication between the inlet and the first outlet and second outlet, where lubricant passing through the conduit exits at the first outlet and second outlet to lubricate the sleeve. Where in a first example of the another representation, the first outlet and second outlet are opposite the internal passage at opposite sides of the body.

In another representation, a system comprising: a pump; one or more conduits connected to the pump; and a plurality of bodies coupled to a shift arm for engaging a sleeve, where each of the plurality of bodies comprises an inlet connected to a conduit from the one or more conduits, at a first outlet, a second outlet, and an internal passage being in fluid communication between the inlet and the first outlet and second outlet, where lubricant passing through the conduit exits at the first outlet and second outlet to lubricate the sleeve. Where in a first example of the another representation, the first outlet and second outlet are opposite the internal passage at opposite sides of each of the bodies.

In another representation, a system comprising: a pump; one or more conduits connected to the pump; and a pair of bodies coupled to a shift arm for engaging a sleeve, where the pair of bodies includes a first body and a second body, where each of the pair of bodies comprises an inlet connected to a conduit from the one or more conduits, at a first outlet, a second outlet, and an internal passage being in fluid communication between the inlet and the first outlet and second outlet, where lubricant passing through the conduit exits at the first outlet and second outlet to lubricate the sleeve. Where in a first example of the another representation, the first outlet and second outlet are opposite the internal passage at opposite sides of each of the bodies.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

Note that the example control and estimation routines included herein can be used with various engine, electric machine, transmission, and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system comprising:
a pump;
one or more conduits connected to the pump; and
at least one body coupled to a shift arm for engaging a sleeve, where the at least one body comprises an inlet connected to a conduit from the one or more conduits, at least one outlet, and an internal passage being in fluid communication between the inlet and the at least one outlet, where lubricant passing through the conduit exits at the at least one outlet to lubricate the body and the sleeve.

2. The system of claim 1, where the at least one body is positioned inboard of the shift arm and outboard of the sleeve of a clutch assembly, such that the at least one outlet faces and is in fluid communication with the sleeve, where the at least one outlet is contiguous with and fluidly couples a contact surface that makes surface sharing contact with the sleeve.

3. The system of claim 2, where the conduit is positioned outboard of the shift arm and the inlet fluidly couples to the conduit outboard the shift arm.

4. The system of claim 3, where the shift arm has a fitting for the at least one body, where the fitting has an opening outboard the shift arm, where the conduit fluidly couples and connects to the inlet via the opening.

5. The system of claim 4, where the shift arm is a shift fork, where the shift fork includes a pair of arms including a first arm and a second arm, where the at least one body is a shift fork pad.

6. The system of claim 5, a pair of mounting components that each receive a respective body of a plurality of bodies that includes the at least one body, where the pair of mounting components includes a first mounting component physically coupled to the first arm and a second mounting component physically coupled to the second arm.

7. The system of claim 6, where there are a pair of bodies, with a first body and a second body, where the first body physically couples the first mounting component, and the second body physically couples to the second mounting component, where at least the first body or the second body is the at least one body comprising the inlet connected to the conduit, the at least one outlet, and the internal passage.

8. The system of claim 7, where the first body and second body are positioned outboard of the sleeve and inboard of the shift fork, such that the first body physically couples to the first mounting component and the second body physically couples to the second mounting component.

9. The system of claim 8, where there are a pair of conduits, including a first conduit and a second conduit that are connected to outlets of the pump.

10. The system of claim 9, where the first body and the second body are embodiments of the at least one body, where each of the first body and the second body comprise a complementary inlet connected to a complementary conduit from the one or more conduits, at least one outlet, and a complementary internal passage.

11. The system of claim 10, where the first body is connected to the first conduit and the second body is connected to the second conduit.

12. The system of claim 11, where the first mounting component has a first fit and the second mounting component has a second fit, where the first fit receives the first body and the second fit receives the second body, where the first fit has a first opening and the second fit has a second opening, where first opening and second opening face outboard the shift fork, where the first conduit fluidly couples and connects to a first inlet of the first body via the first opening, where the second conduit fluidly couples and connects to a second inlet of the second body via the second opening.

13. The system of claim 1, where there is a plurality of outlets in addition to the at least one outlet, where each of the plurality of outlets are fluidly coupled to the inlet via the internal passage.

14. The system of claim 13, where the plurality of outlets is a pair of outlets, including a first outlet and a second outlet, where the first outlet fluidly couples a first contact surface and the second outlet fluidly couples a second contact surface.

15. A system comprising:
an oil pump;
one or more oil conduits connected to the oil pump;
and at least one shift fork pad comprising an oil inlet connected to an oil conduit from the one or more oil conduits, at least one oil outlet, and an internal passage being in fluid communication between the oil inlet and the at least one oil outlet.

16. The system of claim 15, where the at least one shift fork pad includes a pad and a stem, where the pad physically contacts a first surface of a shift sleeve when shifted via a shift fork, and where the stem is received by a fit of the shift fork, where the oil inlet is contiguous with a second surface of the stem, and the fit has an opening where the oil conduit fluidly couples and connects to the oil inlet via the opening.

17. The system of claim 16, where there is a first shift fork pad and a second shift fork pad, where the first shift fork pad and second shift fork pad are embodiments of the at least one shift fork pad, where each of the first shift fork pad and the second shift fork pad comprise an inlet connected to a conduit from the one or more oil conduits, the at least one oil outlet, and the internal passage.

18. The system of claim 15, where the at least one shift fork pad includes pair of outlets including a first outlet and a second outlet, where the first outlet fluidly couples a first contact surface and the second outlet fluidly couples a second contact surface.

19. A method for lubricating a shift sleeve via a shift fork comprising:
pressurizing lubricant via a pump;
the lubricant exiting the pump via a first outlet of the pump;
directing the lubricant from the first outlet to a conduit;
directing the lubricant through the conduit to the shift fork;
directing the lubricant from the shift fork to an at least one body physically coupled to the shift fork;
directing the lubricant into a respective inlet of the at least one body;
directing the lubricant from the respective inlet to a respective outlet of the at least one body via a passage internal to the at least one body, where the passage fluidly couples the respective inlet to the respective outlet;
the lubricant exiting the respective outlet to lubricate a first surface of the at least one body;
the lubricant contacting a surface of the shift sleeve, where the shift sleeve is shiftingly coupled to the shift fork, and the first surface contacts the surface;
and the lubricant lubricating the shift sleeve.

20. The method of claim 19, where after pressurizing the lubricant via the pump; the lubricant is split between the first outlet and a second outlet, where a first flow path directs lubricant to exit the pump via the first outlet, enter a first conduit from the first outlet, to the shift fork via the first conduit, to a first body from the shift fork and the first conduit, into a first complementary inlet of the first body, into a first fluid passage of the first body from the first complementary inlet, to a first complementary outlet of the first body, from the first outlet to the first surface of the of the first body, and from the first surface to the surface of the shift sleeve, where a second flow path directs lubricant to exit the pump via the second outlet, enter a second conduit from the second outlet, to the shift fork via the second conduit, to a second body from the shift fork and the second conduit, into a second complementary inlet of the second body, into a second fluid passage of the second body from the second complementary inlet, to a second complementary outlet of the second body, from the second complementary outlet to a second surface of the second body, and from the second surface to the surface of the shift sleeve.
